(19) United States
(12) Patent Application Publication
(10) Pub. No.: US 2012/0222120 A1
(43) Pub. Date: Aug. 30, 2012

(54) MALWARE DETECTION METHOD AND MOBILE TERMINAL REALIZING THE SAME

(75) Inventors: Heung Soon RIM, Yongin-si (KR); Kyung Hee LEE, Yongin-si (KR); Hyung Chul JUNG, Suwon-si (KR); Ji Hyun LEE, Yongin-si (KR); Sung Kyu CHO, Suwon-si (KR)

(73) Assignee: SAMSUNG ELECTRONICS CO. LTD., Suwon-si (KR)

(21) Appl. No.: 13/099,705

(22) Filed: May 3, 2011

(30) Foreign Application Priority Data
Feb. 24, 2011 (KR) 10-2011-0016280

(51) Int. Cl. G06F 11/00

(52) U.S. Cl. 726/24

(57) ABSTRACT

A malware detection method and a mobile terminal realizing the same are provided. The method monitors execution of applications on the mobile terminal, notifies a user of perceived malicious behavior and guides handling of a detected malicious application. The malware detection method includes extracting, when a platform Application Programming Interface (API) is called by an application, an action of the application from the platform API, determining, when the extracted action is a preset trigger action, whether the application is a malware program by comparing the extracted action with a malware pattern file, and outputting, when the application is a malware program, an alert message.

### PRIORITY

This application claims the benefit under 35 U.S.C. §119(a) of a Korean patent application filed on Feb. 24, 2011 in the Korean Intellectual Property Office and assigned Serial No. 10-2011-0016280, the entire disclosure of which is hereby incorporated by reference.

### BACKGROUND OF THE INVENTION

1. Field of the Invention

The present invention relates to malware detection in a mobile terminal. More particularly, the present invention relates to a malware detection method and a mobile terminal realizing the same that monitor execution of applications on the mobile terminal, notify a user of perceived malicious behavior and guide handling of a detected malicious application.

2. Description of the Related Art

With advances in electronics and communication technology, mobile terminals provide various functions to users. In particular, unlike phones having limited functions, various applications downloaded from an application market or an application store may be installed on smart phones. A malicious program, for example, a program leaking personal information or causing unnoticed payment without a user's consent, may be present among such applications. The number of malicious programs continues to rise.

There are two general approaches to malware detection. The first approach is to scan application codes to detect malware. Anti-virus programs employ this approach. Signatures specific to malware codes are maintained in a database. A malware detection program installed in a Personal Computer (PC) or a smart phone scans application codes with reference to the signature database. The second approach is to monitor a currently running application in real time to examine whether the application performs a malicious action. The second approach may overcome weaknesses of the first approach which relies upon signatures of already known malware codes.

Real time malware detection according to the second approach may be realized using the following three components: a monitoring part monitoring behavior of an application, a malware pattern file defining malicious actions, and an engine part determining whether a specific application is malware by comparing actions of the application with actions specified in the malware pattern file.

The behavior information of an application may be collected by analyzing events at the kernel level, by analyzing Application Programming Interface (API) routines at the operating system level, or by other means. The behavior information is used to detect a malicious action in a similar way regardless of the level at which behavior information is collected.

However, the existing signature-based approach using signatures of known malware codes may be incapable of detecting novel malware codes that are ever increasingly diversified and complicated.

The existing malware detection approach based on real-time monitoring may be more effective in malware detection than the signature-based approach which utilizes to real-time monitoring of application behavior. However, as this real-time monitoring approach has been developed in PC environments, it may not be adequate for smart phones in some aspects. For utilization in smart phones, the real-time monitoring approach should to be enhanced in the following ways. First, malicious actions in a smart phone (for example, leaking address books, leaking messages, leaking photographs, inducing unwanted payment and consuming battery power) are different from those in a PC. Hence, malicious actions are to be defined in a manner conforming to smart phone environments. Second, in a smart phone, a malicious action tends to be realized using the API provided by a platform of the smart phone. Hence, it is necessary to consider the platform of the smart phone should be considered. Here, the platform is a layer between the Operating System (OS) and the application in the layering hierarchy of a smart phone. For example, the OS may be the Linux kernel or Real Time OS (RTOS); the platform may be Android from Google, iOS from Apple, or Bada from Samsung. Third, malware programs tend to perform suspicious actions (for example, inducing payment, inducing cellular data communication, transmission of spam messages and placing international calls) after a series of normal operations or immediately upon execution. Hence, actions suspected of being malicious (referred to as “trigger actions”) to detect a malware program should be defined. Fourth, malware detection should not excessively consume system resources such as battery power, Central Processing Unit (CPU) capacity and memory capacity. Fifth, a simple and accurate engine for malware analysis is desired.

The existing real-time monitoring approach tends to collect events at the kernel layer to detect a malicious action. However, events collected at the kernel layer, for example “read” or “send,” may be too simple to be useful for detecting a malicious action.

In addition, the existing real-time monitoring approach may monitor API routines called by applications to detect a malicious action using a sequence of names of the called API routines. However, this may identify only a list of called API routines, which does not reveal information on actual application actions and thus is insufficient for determining a malicious action. When information related to API calling sequences is not specified in the malware pattern file, a corresponding malicious action may go undetected.

### SUMMARY OF THE INVENTION

Aspects of the present invention are to address at least the above-mentioned problems and/or disadvantages and to provide at least the advantages described below. Accordingly, an aspect of the present invention is to provide a malware detection method based on real-time monitoring adapted for a mobile terminal capable of freely installing and uninstalling applications.

Another aspect of the present invention is to provide a malware detection method based on real-time monitoring that collects more detailed information regarding application actions at a platform Application Programming Interface (API) layer rather than at a kernel layer.

Another aspect of the present invention provides a real-time malware detection algorithm adapted to smart phones in which API routines invoked by an application are carefully analyzed in terms of actions to detect malicious behavior in real time. When malicious behavior is detected, the algorithm notifies the user of the application suspected of being malware and the malicious behavior. For security, the user may remove the suspicious application and report the malicious behavior to a remote analysis server. The analysis server closely examines the reported application and its behavior, and reports, if the application is determined to be malware, the application to the application store. The application store may delete the application and invoke a remote removal service to remove copies thereof in the distribution channel. Hence, the provided algorithm contributes to construction of an application ecosystem and a security ecosystem.

Another aspect of the present invention is to provide a malware detection method based on real-time monitoring wherein API routines called by an application are analyzed in terms of a conducted action and an object and method used by the action to increase the accuracy of malware determination.

In accordance with an aspect of the present invention, a malware detection method for a mobile terminal is provided. The method includes extracting, when a platform API is called by an application, an action of the application from the platform API, determining, when the extracted action comprises a preset trigger action, whether the application is a malware program by comparing the extracted action with a malware pattern file, and outputting, when the application is a malware program, an alert message.

According to another aspect of the present invention, the extracting of the action of the application may include identifying, when the platform API is called by the application, a called API routine, and extracting an application action, an object used by the application action and a method used by the application action from the identified API routine, and classifying the extracted action, object and method.

According to another aspect of the present invention, the determining of whether the application comprises the malware program may include determining whether the application is present in a malware program list, determining, when the application is not present in the malware program list, whether the extracted action comprises a preset trigger action, determining, when the extracted action comprises the trigger action, whether the object used by the action is present in a whitelist, comparing, when the object used by the extracted action is not present in the whitelist, the extracted action with the malware pattern file, and creating, when the application is determined to be a malware program, a log file to be sent to an analysis server. According to another aspect of the present invention, the determining of whether the extracted action comprises the preset trigger action may include determining the extracted action to comprises the trigger action when the extracted action corresponds to one of object disclosure, object creation, object movement, object deletion, object reading, object setting, object modification, object downloading, service subscription, object execution, inducing payment, inducing spamming, phishing, advertisement, sound recording, video recording and spreading. According to another aspect of the present invention, the log file may contain the extracted action and the object and method used by the action.

According to another aspect of the present invention, the outputting of an alert message may include displaying, when the application comprises the malware program, the alert message, sending the log file to the analysis server, and uninstalling the application when a delete command is entered from an input unit after displaying the alert message.

In accordance with another aspect of the present invention, a mobile terminal is provided. The terminal includes an extraction part for extracting, when a platform API is called by an application, an action of the application from the API, a collection part for collecting the application action extracted by the extraction part, a monitoring part for receiving the application action from the collection part, for determining whether the application action comprises a preset trigger action, for reading, when the application action is a trigger action, a malware pattern file from a storage unit, and for determining whether the application comprises a malware program by comparing the application action with the malware pattern file, and a security User Interface (UI) part for outputting, when an alert signal is received from the monitoring part, an alert message about the application.

According to another aspect of the present invention, in a hierarchy of layers including a hardware layer, an operating system layer, a platform layer and an application layer, the extraction part, the collection part and the monitoring part belong to the platform layer.

According to another aspect of the present invention, the malware detection method enables users of mobile terminals supporting easy application installation like smart phones and tablet Personal Computers (PCs) to cope with the ever-increasing amount of malware. For effective malware detection, the method is based on actions classified according to characteristics of the mobile terminal. The method may be implemented in a resource efficient way and be run as a resident program in the mobile terminal. More specifically, the method of the present invention may include the following attributes.

First, the method may be implemented as a program installed by default in a mobile terminal and provide security information to the user in an easily understandable manner for safe utilization of the mobile terminal. The method notifies the user of a suspicious action as a security alert, enabling the user to determine whether the notified action is an intended operation. With help of the method, the user may remove the corresponding program or send the security alert to a remote server.

Second, with the increasing amount of malware, it is necessary to examine security aspects of applications in advance. According to an aspect of the present invention, the method of the present invention may provide security information to the user in the course of daily use of a smart phone and act as a pre-examination process for security. Pre-examination for security requires code scanning or dynamic execution of an application under examination. Code scanning alone may be insufficient for accurate security examination. Dynamic execution for security examination may require a security expert, entailing high costs. According to another aspect of the present invention, the method of the present invention may provide security information to the user of a mobile terminal and identify a malicious action without expert intervention. Hence, the method may be used as a security pre-examiner.

Third, according to another aspect of the present invention, users using the method of the present invention may report various malware to a remote server. The server may analyze the reported malware in various ways, maintain them in a malware database, and provide the analysis results to the application market. Hence, the method may contribute to secure application distribution.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram of a mobile terminal according to an exemplary embodiment of the present invention;

FIG. 2 illustrates a configuration of a control unit in the mobile terminal of FIG. 1 according to an exemplary embodiment of the present invention;

FIG. 3 illustrates a hierarchy of layers in a mobile terminal according to an exemplary embodiment of the present invention;

FIG. 4 illustrates operations of a monitoring part in a mobile terminal according to an exemplary embodiment of the present invention;

FIG. 5 illustrates operations of a malware action analysis engine in a mobile terminal according to an exemplary embodiment of the present invention;

FIG. 6 is a flow chart of a malware detection method according to another exemplary embodiment of the present invention;

FIGS. 7 and 8 illustrate screen representations for malware handling according to an exemplary embodiment of the present invention; and

FIG. 9 illustrates an overall scenario for handling malware according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

A mobile terminal of exemplary embodiments of the present invention is a terminal or user equipment that can wirelessly access networks and can freely install and uninstall applications. Smart phones and tablet Personal Computers (PCs) are examples of the mobile terminal of exemplary embodiments of the present invention. However, the present invention is not limited thereto, and other electronic devices prone to malware may be examples of the mobile terminal of exemplary embodiments of the present invention. Here, the networks include the Internet, mobile communication networks and other similar data and communication networks. A mobile terminal may wirelessly access the Internet via a mobile communication network using Wireless Application Protocol (WAP) or Wireless Internet Platform for Interoperability (WIPI), via a wireless Local Area Network (LAN) using access points, or via a portable Internet service such as Wireless Broadband (WiBro) or Worldwide Interoperability for Microwave Access (WiMax) enabling high-speed Internet access while in motion. A mobile communication network is composed of base stations and controllers controlling the same, may be a synchronous or asynchronous system, and may be any mobile network based on Code Division Multiple Access (CDMA), Global System for Mobile communications (GSM), third generation, enhanced third (3.5) generation or fourth generation wireless technology.

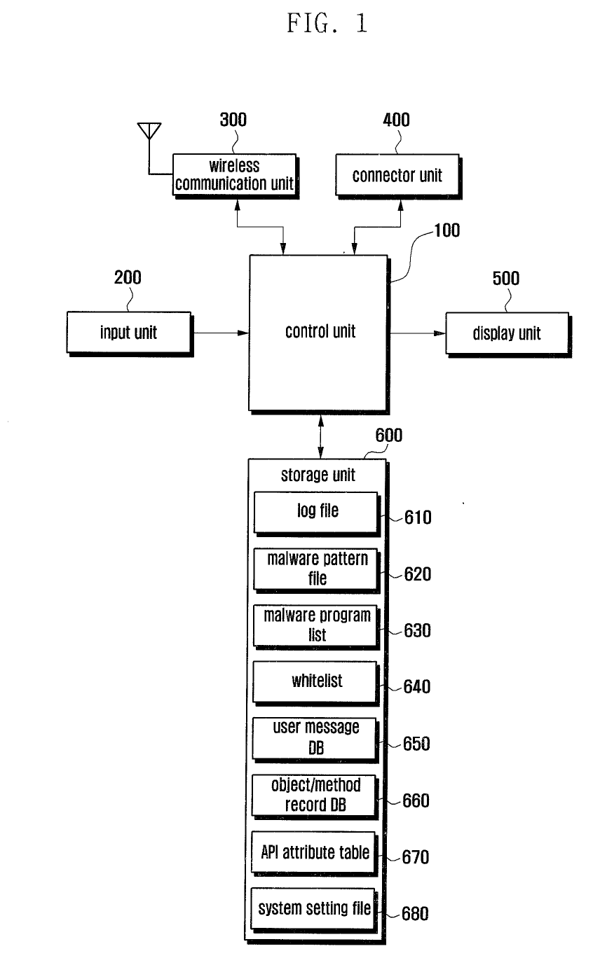

FIG. 1 is a block diagram of a mobile terminal according to an exemplary embodiment of the present invention.

Referring to FIG. 1, the mobile terminal may include a control unit 100, an input unit 200, a wireless communication unit 300, a connector unit 400, a display unit 500, and a storage unit 600.

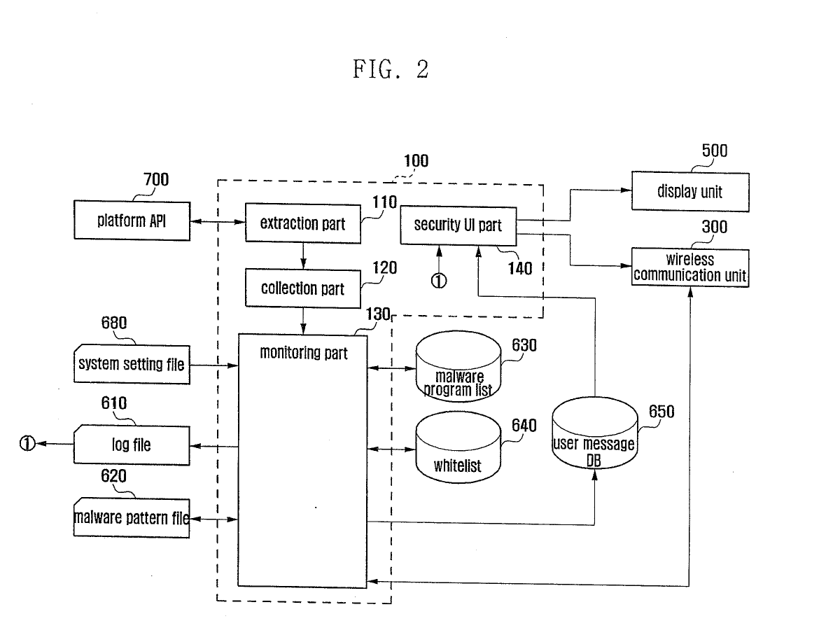

The control unit 100 controls the overall operation of the mobile terminal. In particular, the control unit 100 analyzes Application Programming Interface (API) routines called by an application and identifies actions of the application to detect malicious actions in real time. Malware detection is described in detail with reference to FIGS. 2 to 5.

The input unit 200 may include a touchscreen, one or more buttons and a keypad, and sends an input signal corresponding to a key or touch event generated by the user to the control unit 100. However, the present invention is not limited thereto, and the input unit 200 may include any suitable input item or element.

The wireless communication unit 300 includes a mobile communication module to communicate with a base station, and sends data from the control unit 100 to the base station and forwards data received from the base station to the control unit. The wireless communication unit 300 may further include a Wireless-Fidelity (Wi-Fi) module to access a local area network.

The connector unit 400 connects an external device to the control unit 100 through a wired or wireless connection. The connector unit 400 sends data from the control unit 100 to the external device and forwards data from the external device to the control unit 100. The connector unit 400 may include a Universal Serial Bus (USB) terminal, a headset jack, a Bluetooth module, a terminal adapter or other similar connectors, terminals, jacks or modules.

The display unit 500 may include a Graphics Processing Unit (GPU) and a video Random Access Memory (RAM), and may be realized using a retinal display, Active Matrix Organic Light Emitting Diode (AMOLED) technology, Thin Film Transistor-Liquid Crystal Display (TFT-LCD) technology, or other similar display technologies.

The storage unit 600 may be divided into a program area and a data area. The program area may store drivers, an operating system, platforms, APIs and applications and other similar programs. The data area stores data generated by execution of programs. In particular, as shown in FIG. 1, the data area stores a log file 610, a malware pattern file 620, a malware program list 630, a whitelist 640, a user message Database (DB) 650, an object/method record DB 660, an API attribute table 670, and a system setting file 680. These are described in detail with reference to FIGS. 2 to 5.

FIG. 2 illustrates a configuration of a control unit in the mobile terminal of FIG. 1 according to an exemplary embodiment of the present invention.

Referring to FIG. 2, a control unit 100 may include an extraction part 110, a collection part 120, a monitoring part 130, and a security User Interface (UI) part 140.

When a routine of a platform API 700 is called by an application, the extraction part 110, the extraction part 110 analyzes the called API routine to extract information regarding an application action, and an object and method used by the application action, and sends the analysis results as a system message to the collection part 120. Application actions, objects and methods are illustrated respectively in Table 1, Table 2 and Table 3. However, the present invention is not limited thereto, and the contents of Tables 1 to 3 are only for illustration.

Table 1 illustrates classified actions of applications.

TABLE 1

| Action | Description |
|---|---|
| Disclose | Disclosure of object |
| Create | Creation of object |
| Move | Movement of object to other place |
| Delete | Deletion of object |
| Get | Reading object details |
| Set | Set object to new data |
| Modify | Modification of object details |
| Download | Download of object |
| Subscribe | Subscription to service |
| Execute | Execution of object |
| Cost | Inducing payment |
| Spam | Inducing spamming |
| Phishing | Inducing phishing |
| Spread | Posting, spreading or denial of service attack |
| Advert | Advertisement |
| Record | Sound or video recording |

Table 2 illustrates classified objects, which may be utilized by application actions.

TABLE 2

| Type | Object |
|---|---|
| Common information | User name |
| | User ID |
| | User password |
| | Phone number |
| | Email address |
| | URL information |
| | Cookie information |
| | Date information |
| | Time information |
| | Location information |
| | Device information |
| Personal information | Family name |
| | Name |
| | Nickname |
| | Birth day |
| | Occupation |
| | Company |
| | Anniversary |
| | Address |
| | Messenger address |
| | Works to do |
| SIM information | ICCID |
| | MCC |
| | MNC |
| | Operator name |
| | SPN |
| System information | File |
| | Directory |
| | Database |
| | Registry |
| Media | Audio |
| | Video |
| | Photograph |
| Recipient information | Phone number (TO) |
| | Phone number (CC) |
| | Phone number (BCC) |
| | Email(TO) |
| | Email(CC) |
| | Email(BCC) |
| | URL(TO) |
| | IP(TO) |

Table 3 illustrates classified methods, which may be utilized by application actions.

TABLE 3

| Type | Method | Description |
|---|---|---|
| Network | Socket | Communication using socket |
| | HTTP | Communication using Http |
| | SMS | Communication using SMS |
| | MMS | Communication using MMS |
| | Email | Communication using Email |
| Device | Bluetooth | Communication using Bluetooth |
| | | device |
| | WIFI | Communication using WIFI |
| | Timer/Alarm | Use of timer or alarm of device |
| Service | Service | Use of specific service |

The collection part 120 collects API information related to actions, objects and methods from the extraction part 110, and sends the API information, as an easily processible system message, to the monitoring part 130. For example, the collection part 120 may assign an identifier to the API information for easy application identification. The collection part 120 may also assign identifiers to each action, object and method.

The monitoring part 130 reads a malware program list 630 when an application is executed, and determines whether the application is malware by referencing the malware program list 630. When the application is malware that is listed in the malware program list 630, the monitoring part 130 records a corresponding alert message in the user message DB 650. Then, the security UI part 140 controls the display unit 500 to display a guide message, such as “This application is known malware”.

When the application is not malware listed in the malware program list 630, the monitoring part 130 determines whether the application action reported by the collection part 120 is a preset trigger action. A trigger action is described above and may be one of the actions listed in Table 1. When the application action is a trigger action, the monitoring part 130 reads a whitelist 640 and determines whether an object used by the application action is present in the whitelist 640. Here, the whitelist 640 is a list of data items directly created or stored by the user. For example, the whitelist 640 may contain a phonebook and favorites or other similar user generated information. When the object used by the application action is present in the whitelist 640, the monitoring part 130 determines the application action to be normal.

When the object used by the application action is not present in the whitelist 640, the monitoring part 130 tentatively determines the application action to be abnormal. For example, when an application attempts to perform a Short Message Service (SMS) transmission, wherein the SMS is a method and the transmission is an action, to a contact number, which is an object, that is neither entered through the input unit 200 (see FIG. 1) nor listed in the phonebook, the monitoring part 130 regards the application action as abnormal. When the application action is determined to be abnormal, the monitoring part 130 reads a malware pattern file 620 and determines whether the application action, which is a trigger action, matches a malware action pattern in the malware pattern file 620. In addition, when the application has performed one or more actions before the trigger action, the monitoring part 130 determines whether the actions before the trigger action match a malware action pattern in the malware pattern file 620. When the trigger action and the preceding actions do not match a malware action pattern in the malware pattern file 620, the monitoring part 130 determines the application action to be normal. When the trigger action or the preceding actions match a malware action pattern in the malware pattern file 620, then the monitoring part 130 determines the application action to be malicious and records a corresponding alert message in the user message DB 650. Then, the security UI part 140 controls the display unit 500 to output an alert message, such as “the application is conducting an action suspected to be malicious”. The alert message may be output to the user as an icon or popup. When the user enters an input via the input unit 200 or makes a touch gesture on the icon or popup, the security UI part 140 controls the display unit 500 to output detailed information on the application action determined to be malicious (for example, “the wallpaper application sends an SMS message to phone number ttt”) together with a guide message recommending removal of the corresponding application.

When the user enters a “delete” command in response to the outputting of the alert message, the monitoring part 130 finally determines the application action to be malicious and uninstalls the corresponding application. That is, the monitoring part 130 may remove an application according to a delete command from the input unit 200. When the user enters a “keep” command or a “save” command, the monitoring part 130 determines the application action to be normal according to a decision by the user or according to a process or entity known to the user, and adds the object used by the action to the whitelist 640. The method used by the action may also be added to the whitelist 640.

When the application action matches a malware action pattern in the malware pattern file 620 or the application action is determined to be malicious by the user, the monitoring part 130 may create a log file 610 to be reported to an analysis server (not shown), may store the log file 610 in the storage unit 600 (see FIG. 1), and may request the security UI part 140 to display a message recommending that the user send the log file 610 to the analysis server. Here, the log file 610 contains information regarding the action suspected or determined to be malicious and the object and method used by the action. The log file 610 may further contain information regarding actions performed before the action that is suspected or determined to be malicious and objects and methods used by the actions.

The monitoring part 130 may control a wireless communication unit 300 in order to send the log file 610 to the analysis server. Specifically, when the mobile terminal is in Wi-Fi mode, and thus communication is free, the monitoring part 130 may control the wireless communication unit 300 to send the log file 610 to the analysis server (not shown). The monitoring part 130 may also control the wireless communication unit 300 in order to send the log file 610 to the analysis server in response to a transmit command from the input unit 200. The log file sent to the analysis server will be investigated by a group of security experts and investigation results will be accumulated. The analysis server may periodically update the malware program list 630 and the malware pattern file 620 of the mobile terminal.

The monitoring part 130 may also control the wireless communication unit 300 to receive a new malware program list 630 and malware pattern file 620 and store the received malware program list 630 and malware pattern file 620 in the storage unit 600.

The security UI part 140 manages applications, the user message DB 650 and the log file 610, and controls output of alert messages and reporting of the log file 610 to the analysis server.

More specifically, when the monitoring part 130 records an alert message associated with a malware program or an application action determined to be abnormal or malicious in the user message DB 650, the security UI part 140 controls the display unit 500 to output the alert message to the user.

In response to a request from the monitoring part 130, the security UI part 140 controls the display unit 500 to output a guide message recommending removal of an application or reporting of a log file.

When the mobile terminal is in Wi-Fi mode or a command for log file transfer is entered through the input unit 200, the security UI part 140 may control the wireless communication unit 300 to send the log file 610 to the analysis server.

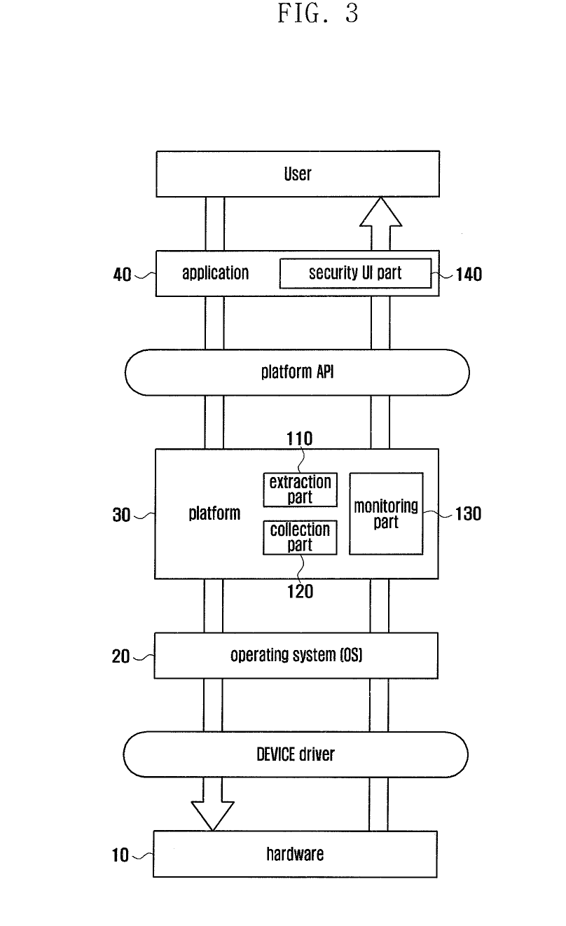

FIG. 3 illustrates a hierarchy of layers in a mobile terminal according to an exemplary embodiment of the present invention.

Referring to FIG. 3, the mobile terminal may have hierarchical layers: a hardware layer 10, which is the lowest layer, a device driver layer, an Operating System (OS) layer 20, a platform layer 30, a platform API layer and an application layer 40, which is the highest layer. Device drivers, which are included in the device driver layer, serve as an interface between hardware and software. The platform API, provided by the platform to applications, is an interface that enables one application to utilize the OS, platform, database or another application. The OS performs scheduling and memory management for real time processing. The Linux kernel or Real Time OS (RTOS) is an example of the OS. The platform supporting execution of applications may be Android from Google, iOS from Apple, Bada from Samsung, or other similar mobile device platforms.

An extraction part 110, a collection part 120 and a monitoring part 130 may be included in the platform layer 30. In the present exemplary embodiment, as API information is directly collected at the platform layer 30 providing the API, actions of an application may be more accurately identified and more reliable malware detection is possible in comparison to an existing approach. The security UI part 140 may belong to the application layer 40.

Table 4 illustrates actions, objects and methods, derived from the API provided by the Bada platform. The extraction part 110 may utilize such API information.

TABLE 4

| API routine name | Object | Method | Action |
|---|---|---|---|
| Content_ContentTransfer_Download | URL information | HTTP | Download |
| Locations_RemoteLocationProvider_GetTraceData | Location information | Service | Get |
| | User ID | | |
| | Time information | | |
| | Device information | | |
| Messaging_EmailManager_Send | Unknown | Email | Disclose |
| Messaging_MmsManager_Send | Unknown | MMS | Disclose |
| Messaging_SmsManager_Send | Unknown | SMS | Disclose |
| Net_Bluetooth_Bluetooth_SendData | Unknown | Bluetooth | Disclose |
| Net_HttpCookie_GetCookieValue | Cookie information | Http | Get |
| Net_HttpCredentials_GetName | User ID | Http | Get |
| Net_HttpCredentials_GetName | User password | Http | Get |
| Net_Sockets_SecureSocket_Receive | Unknown | Socket | Download |
| Net_Sockets_SecureSocket_Send | Unknown | Socket | Disclose |
| Net_Wifi_AdhocService_SendBroadcastMessage | Unknown | WIFI | Disclose |
| Net_Wifi_AdhocService_SendUnicastMessage | Unknown | WIFI | Disclose |

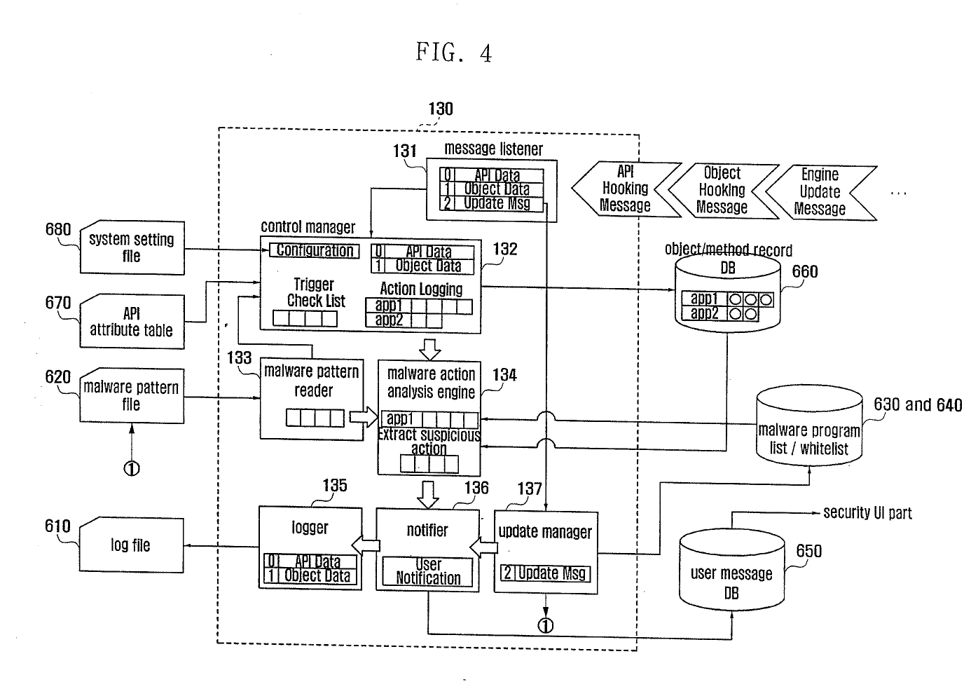

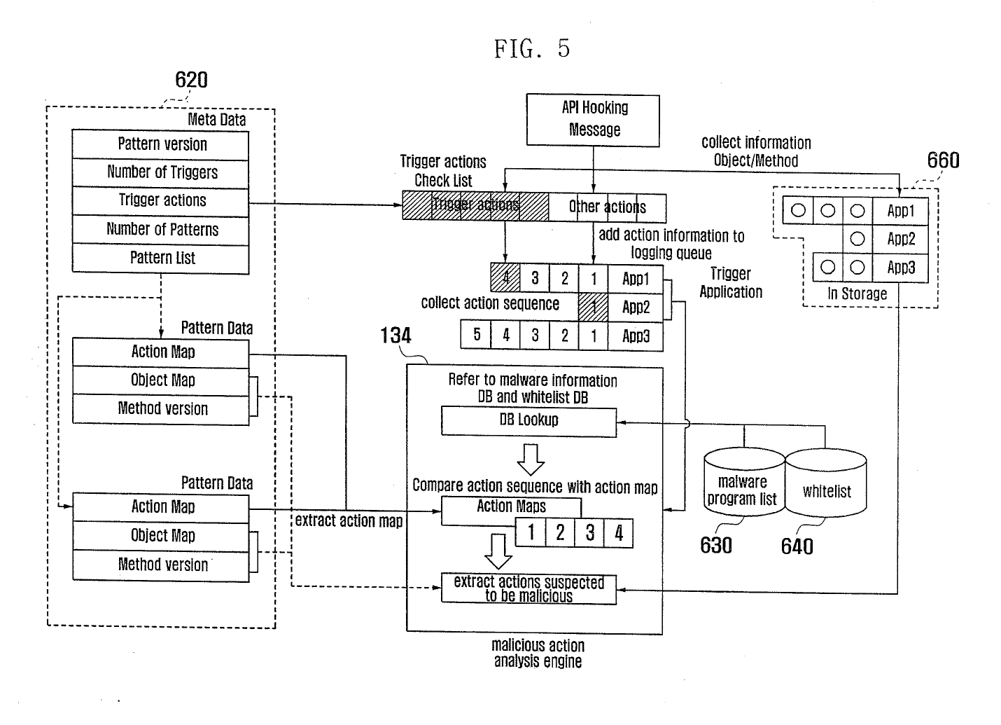

FIG. 4 illustrates operations of a monitoring part in a mobile terminal according to an exemplary embodiment of the present invention, and FIG. 5 illustrates operations of a malware action analysis engine according to an exemplary embodiment of the present invention.

Referring to FIG. 4, a monitoring part 130 may include a message listener 131, a control manager 132, a malware pattern reader 133, a malware action analysis engine 134, a logger 135, a notifier 136, and an update manager 137.

The message listener 131 collects an API hooking message, which is an action and a method, an object hooking message, and an engine update message, which includes updated malware patterns and malware program lists, from the collection part 120 (see FIG. 2) and the wireless communication unit 300 (see FIG. 2). The message listener 131 assigns an identifier to the collected message. The message listener 131 forwards an action, method or object-related message to the control manager 132 and forwards an update-related message to the update manager 137.

The control manager 132 reads an API attribute table 670 and a system setting file 680. The control manager 132 reads a malware pattern file 620 via the malware pattern reader 133.

The control manager 132 operates on the basis of the read information. Specifically, the control manager 132 classifies operations, objects and methods received from the message listener 131 according to applications. The control manager 132 generates a trigger action checklist. The control manager 132 classifies application actions from the message listener 131 into trigger actions and other actions with reference to the trigger action checklist, and adds the classified actions to a queue. The control manager 132 stores objects and methods from the message listener 131 in an object/method record DB 660. When an application performs a trigger action, the control manager 132 sends other actions performed by the application to the malware action analysis engine 134.

The malware pattern reader 133 reads the malware pattern file 620 and forwards the same to the control manager 132 and to the malware action analysis engine 134. Referring to FIG. 5, the malware pattern file 620 may contain a pattern version, a number of trigger actions, a list of trigger actions, a number of malware action patterns, and a list of malware action patterns. The list of malware action patterns, which is pattern data, may include an action map, an object map and a method map for each pattern. Some malware action patterns are shown below for illustration.

Illustration of Malware Action Patterns

pattern_version=0.0.1;

trigger_action=ACTION_DISCLOSE;

trigger_action=ACTION_CREATE;

trigger_action=ACTION_RECORD;

trigger_action=ACTION_SET;

trigger_action=ACTION_MODIFY;

trigger_action=ACTION_MOVE;

trigger_action=ACTION_DELETE;

trigger_action=ACTION_SPREAD;

trigger_action=ACTION_SPAM;

trigger_action=ACTION_PHISHING;

trigger_action=ACTION_COST;

trigger_action=ACTION_ADVERT;

trigger_action=ACTION_DOWNLOAD;

trigger_action=ACTION_SUBSCRIBE;

pattern_count=2;

pattern=ACTION_GET & ACTION_DISCLOSE;

object_list=OBJ_INFO_COMMON_PHONE_NUMBER;

object_list=OBJ_INFO_PRIV_NOTE;

object_list=OBJ_INFO_SIM_ICCID;

object_list=OBJ_INFO_RSC_FILE;

object_list=OBJ_MEDIA_VIDEO;

object_list=OBJ_ITEM_PROVIDER;

method_list=METHOD_NET_HTTP;

method_list=METHOD_SERVICE;

method_list=METHOD_DEVICE_WIFI;

method_list=METHOD_SDK_EXECUTE;

pattern=ACTION_SET;

object_list=OBJ_INFO_COMMON_DATETIME;

object_list=OBJ_INFO_COMMON_DATE;

object_list=OBJ_INFO_COMMON_TIME;

method_list=METHOD_UNKNOWN;

method_list=METHOD_DEVICE_TIMER;

The malware action analysis engine 134 receives an action map from the malware pattern reader 133. The malware action analysis engine 134 reads a malware program list 630 and a whitelist 640.

When a newly installed application is executed, the malware action analysis engine 134 determines whether the application is present in the malware program list 630. When the application is present in the malware program list 630, the malware action analysis engine 134 informs the notifier 136 of the application name.

When actions including a trigger action are reported by the control manager 132, the malware action analysis engine 134 examines whether the object used by the trigger action is present in the whitelist 640. When the object used by the trigger action is present in the whitelist 640, the malware action analysis engine 134 determines the trigger action to be normal. Otherwise, the malware action analysis engine 134 determines the trigger action to be abnormal.

When the trigger action is determined to be abnormal, the malware action analysis engine 134 examines whether the actions other than the trigger action match the malware action pattern map. When the actions other than the trigger action do not match the malware action pattern map, the malware action analysis engine 134 determines the trigger action to be normal. When the actions other than the trigger action match the malware action pattern map, the malware action analysis engine 134 determines the trigger action to be malicious, informs the notifier 136 of the actions, and extracts objects and methods used by the actions from the object/method record DB 660 and sends the extracted objects and methods to the notifier 136.

The logger 135 creates a log file 610 containing actions, objects and methods used by the actions sent by the notifier 136, and stores the log file 610 in the storage unit 600.

When an application name is reported by the malware action analysis engine 134, the notifier 136 records an alert message indicating malware in the user message DB 650. When actions and objects and methods used by the actions are reported by the malware action analysis engine 134, the notifier 136 records an alert message indicating actions suspected to be malicious in the user message DB 650.

When a trigger action is determined to be malicious or confirmed to be malicious by the user, the notifier 136 forwards actions, and objects and methods used by the actions from the malware action analysis engine 134 to the logger 135.

The update manager 137 receives a malware program list and a malware action pattern from the message listener 131 and updates the existing ones stored in the storage unit 600. The update manager 137 may control the notifier 136 so as to issue an update request message for the malware program list and malware action pattern to the user.

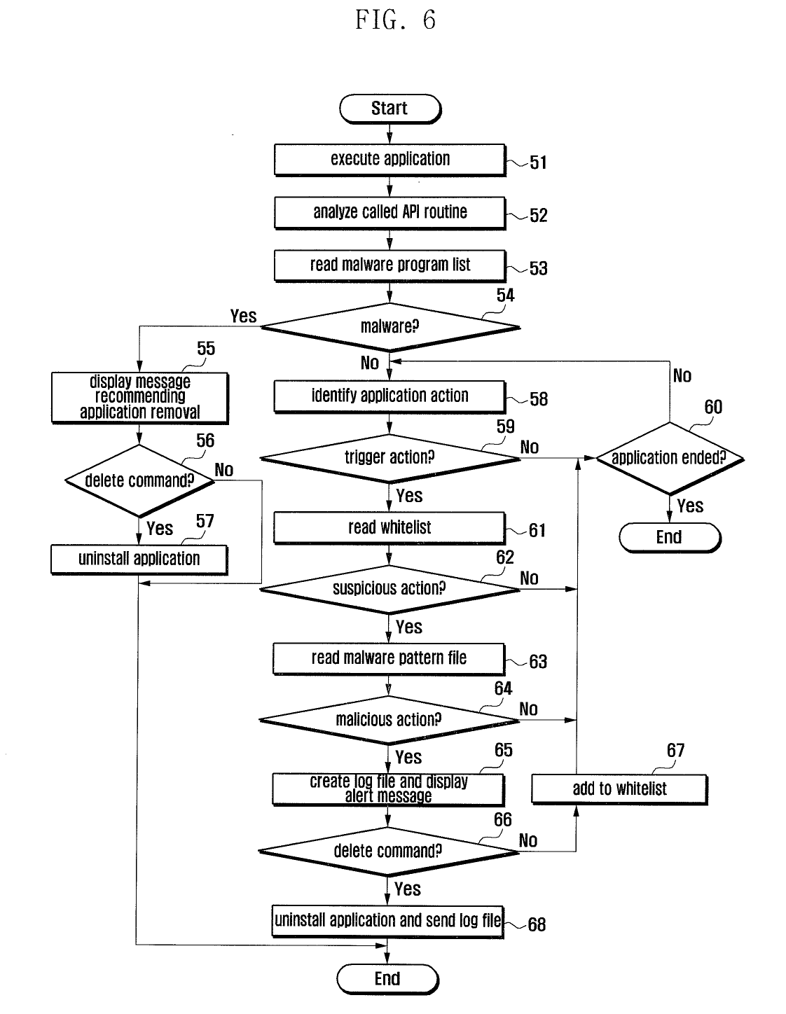

FIG. 6 is a flow chart of a malware detection method according to another exemplary embodiment of the present invention.

Referring to FIGS. 6 and 3, when an application is executed and calls the platform API in step 51, the extraction part 110 identifies the called API routine and extracts information on actions, objects and methods from the called API routine and forwards the extracted information to the monitoring part 130 via the collection part 120 in step 52.

In step 53, the monitoring part 130 reads the malware program list 630 from the storage unit 600. The monitoring part 130 determines whether the application is present in the malware program list 630 in step 54. When the application is present in the malware program list 630, the monitoring part 130 records a corresponding alert message in the user message DB 650. The security UI part 140 controls the display unit 500 so as to display a message recommending removal of the application in step 55. When a “delete” command is entered through the input unit 200 in step 56, then in step 57, the monitoring part 130 uninstalls the application.

When the application is not present in the malware program list 630, the monitoring part 130 identifies the action of the application in step 58 and then, in step 59, determines whether the application action is a preset trigger action. When the application action is not a trigger action, the monitoring part 130 determines whether execution of the application is ended in step 60. When execution of the application is ended, the monitoring part 130 terminates malware detection. When execution of the application is not ended, the monitoring part 130 returns to step 58 and continues malware detection.

When the application action is a trigger action, the monitoring part 130 reads the whitelist 640 in step 61 and, then, in step 62, determines whether the object used by the application action is present in the whitelist 640. When the object used by the application action is present in the whitelist 640, the monitoring part 130 determines the application action to be normal and returns to step 60. When the object used by the application action is not present in the whitelist 640, the monitoring part 130 reads the malware pattern file 620 in step 63 and determines whether the application action (i.e., trigger action) matches a malware action pattern in the malware pattern file 620 in step 64. When the application action does not match a malware action pattern in the malware pattern file 620, the monitoring part 130 determines the application action to be normal and returns to step 60. When the application action matches a malware action pattern in the malware pattern file 620, the monitoring part 130 determines the application action to be malicious and records a corresponding alert message in the user message DB 650 in step 65. Then, the security UI part 140 controls the display unit 500 to output the alert message to the user and output a message recommending removal of the application. Also, at step 65, for the action determined to be malicious, the monitoring part 130 may create a log file and store the log file in the storage unit 600.

When a “keep” command, rather than a “delete” command, is entered from the input unit 200 in step 66, the monitoring part 130 determines the application action to be normal, adds the action, and the object and method used by the action to the whitelist 640 in step 67, and returns to step 60. When a “delete” command is entered from the input unit 200 in step 66, the monitoring part 130 finally determines the application action to be malicious and uninstalls the corresponding application in step 68. At step 68, for the action confirmed to be malicious, the monitoring part 130 may create a log file and store the log file in the storage unit 600. That is, the log file is created when an application action is determined to be malicious after action pattern analysis or an application action determined to be malicious is confirmed to be malicious by the user. At step 68, the monitoring part 130 controls the wireless communication unit 300 to send the log file to the analysis server.

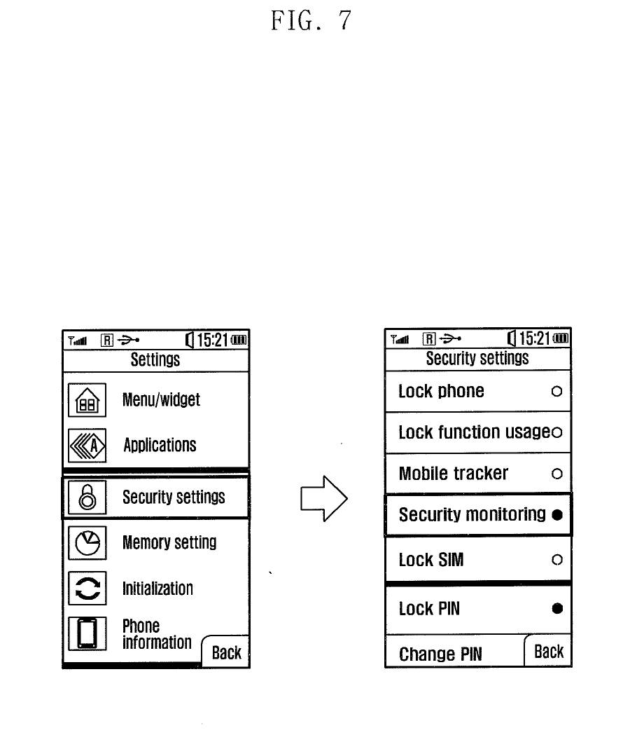

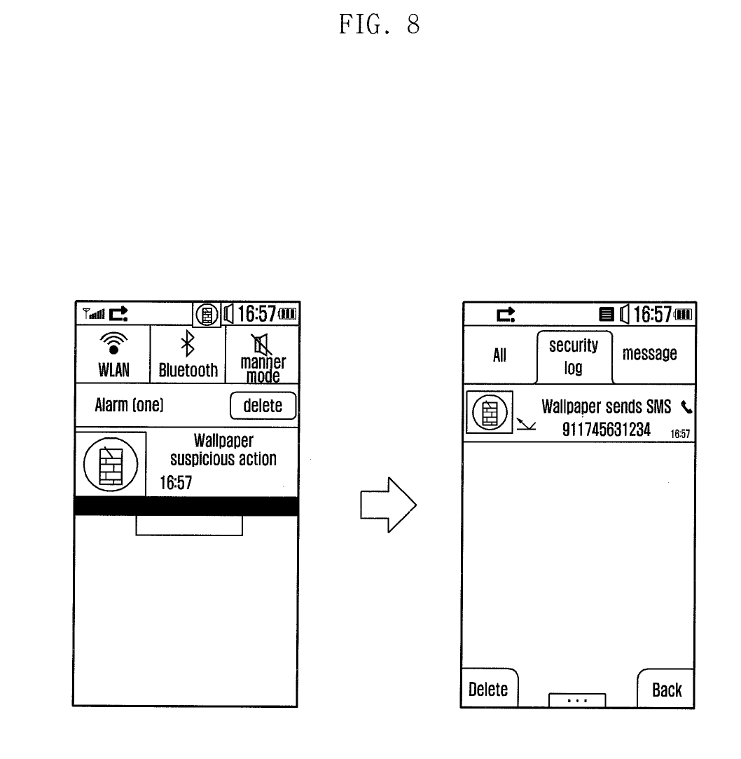

FIGS. 7 and 8 illustrate screen representations for malware handling according to an exemplary embodiment of the present invention.

Referring to FIG. 7, the security UI part 140 provides a User Interface (UI) feature enabling the user to activate security monitoring. As shown in FIG. 8, when an alert message is recorded in the user message DB 650, the security UI part 140 outputs the alert message to the user in real time.

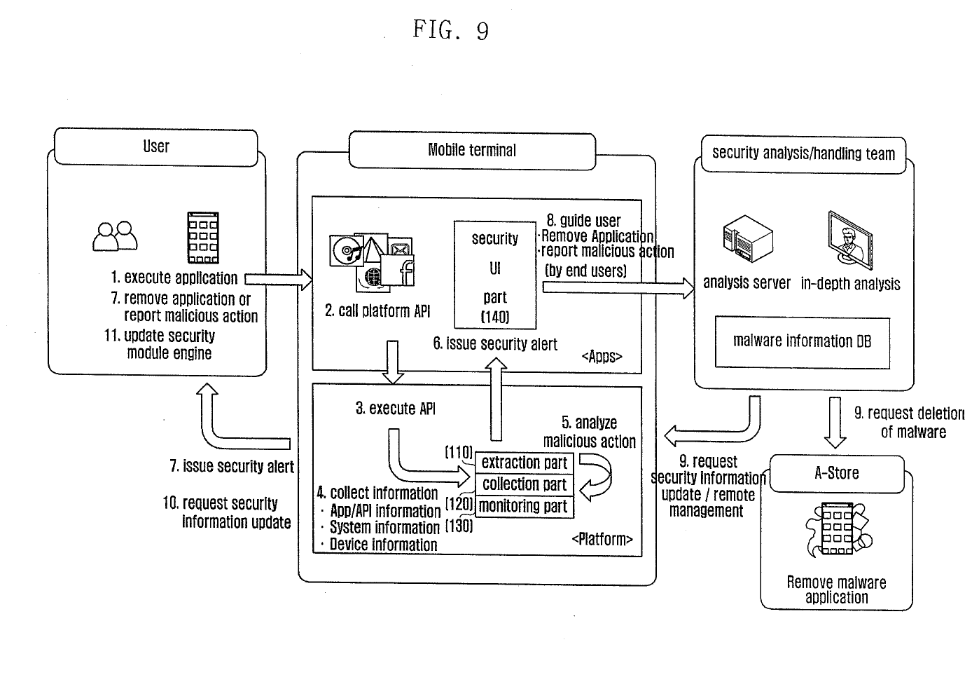

FIG. 9 illustrates an overall scenario for handling malware according to an exemplary embodiment of the present invention.

Referring to FIG. 9, the user executes a specific application in step 1. The application calls the platform API in step 2, and in step 3, the platform executes the called API routine. In step 4, the platform collects information necessary to determine whether the application exhibits malicious behavior. The platform determines whether the application performs a malicious action through analysis in step 5. When the application performs a malicious action, the platform outputs a security alert to the security UI part 140 in step 6. The security UI part 140 outputs an alert message from the mobile terminal to the user in step 7. In step 8, the security UI part 140 recommends that the user uninstall the application and reports the malicious action to the analysis server. The security analysis/handling team closely investigates the reported malicious action with reference to the log file. When the application is determined to be malware after investigation, in step 9, the analysis server sends a request for deleting the application to the application store and sends a security update request to the mobile terminal. The mobile terminal notifies the user of security update information in step 10. Finally, in step 11, the user performs a security update.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A malware detection method for a mobile terminal, the method comprising:
extracting, when a platform Application Programming Interface (API) is called by an application, an action of the application from the platform API;
determining, when the extracted action comprises a preset trigger action, whether the application comprises a malware program by comparing the extracted action with a malware pattern file; and
outputting, when the application comprises a malware program, an alert message.

2. The method of claim 1, wherein the extracting of the action of the application comprises:
identifying, when the platform API is called by the application, a called API routine; and
extracting an application action, an object used by the application action and a method used by the application action from the identified API routine, and classifying the extracted action, object and method.

3. The method of claim 2, wherein the determining of whether the application comprises the malware program comprises:
determining whether the application is present in a malware program list;
determining, when the application is not present in the malware program list, whether the extracted action comprises a preset trigger action;
determining, when the extracted action comprises the trigger action, whether the object used by the action is present in a whitelist; and
comparing, when the object used by the extracted action is not present in the whitelist, the extracted action with the malware pattern file.

4. The method of claim 3, wherein the determining of whether the extracted action comprises the preset trigger action comprises determining the extracted action to comprise the trigger action when the extracted action corresponds to one of object disclosure, object creation, object movement, object deletion, object reading, object setting, object modification, object downloading, service subscription, object execution, inducing payment, inducing spamming, phishing, advertisement, sound recording, video recording and spreading.

5. The method of claim 3, wherein the determining of whether the application comprises the malware program further comprises creating, when the application is determined to comprise the malware program, a log file to be sent to an analysis server, and
wherein the log file contains the extracted action and the object and method used by the action.

6. The method of claim 5, wherein the outputting of the alert message comprises:
displaying, when the application comprises the malware program, the alert message; and
sending the log file to the analysis server.

7. The method of claim 6, wherein the outputting of the alert message further comprises uninstalling the application when a delete command is entered from an input unit after displaying the alert message.

8. The method of claim 6, wherein the sending of the log file to the analysis server comprises transmitting, in response to a transmit command from an input unit, the log file to the analysis server.

9. The method of claim 6, wherein the sending of the log file to the analysis server comprises transmitting, after Wireless-Fidelity (Wi-Fi) connection setup, the log file to the analysis server through the Wi-Fi connection.

10. A mobile terminal comprising:
an extraction part for extracting, when a platform Application Programming Interface (API) is called by an application, an action of the application from the API;
a collection part for collecting the application action extracted by the extraction part;
a monitoring part for receiving the application action from the collection part, for determining whether the application action comprises a preset trigger action, for reading, when the application action comprises the trigger action, a malware pattern file from a storage unit, and for determining whether the application comprises a malware program by comparing the application action with the malware pattern file; and
a security User Interface (UI) part for outputting, when an alert signal is received from the monitoring part, an alert message about the application.

11. The mobile terminal of claim 10, wherein, in a hierarchy of layers including a hardware layer, an operating system layer, a platform layer and an application layer, the extraction part, the collection part and the monitoring part belong to the platform layer.

12. The mobile terminal of claim 11, wherein the extraction part identifies, when the platform API is called by the application, a called API routine, extracts an application action, an object used by the action and a method used by the action from the identified API routine, and classifies the extracted action, object and method.

13. The mobile terminal of claim 12, wherein the monitoring part determines whether the application comprises the malware program by:
determining whether the application is present in a malware program list;
determining, when the application is not present in the malware program list, whether the extracted action comprises a preset trigger action;
determining, when the extracted action comprises a trigger action, whether the object used by the action is present in a whitelist; and
comparing, when the object used by the extracted action is not present in the whitelist, the extracted action with the malware pattern file.

14. The mobile terminal of claim 13, wherein the monitoring part determines the extracted action to comprise the trigger action when the extracted action corresponds to one of object disclosure, object creation, object movement, object deletion, object reading, object setting, object modification, object downloading, service subscription, object execution, inducing payment, inducing spamming, phishing, advertisement, sound recording, video recording and spreading.

15. The mobile terminal of claim 13, wherein the monitoring part stores the malware program list and the malware pattern file received from an analysis server in the storage unit.

16. The mobile terminal of claim 13, wherein the monitoring part creates, when the application is determined to comprise the malware program, a log file to be sent to an analysis server, and
wherein the log file contains the extracted action and the object and method used by the action.

17. The mobile terminal of claim 16, wherein the security UI part controls, in response to a transmit command from an input unit, a wireless communication unit to transmit the log file to the analysis server.

18. The mobile terminal of claim 16, wherein the security UI part controls, after Wireless-Fidelity (Wi-Fi) connection setup, a wireless communication unit to transmit the log file to the analysis server through the Wi-Fi connection.

19. The mobile terminal of claim 10, wherein the security UI part controls, when an alert signal is received from the monitoring part, a display unit to display the alert message about the application.

20. The mobile terminal of claim 19, wherein the security UI part uninstalls the application when a delete command is entered from an input unit after displaying the alert message.
